(19) United States
(12) Patent Application Publication
(10) Pub. No.: US 2012/0167408 A1
(43) Pub. Date: Jul. 5, 2012

(54) Application of Material Properties to Improve Grain Drying

(76) Inventors: Terry J. Siebenmorgen, Fayetteville, AR (US); George Ondier, Houston, TX (US)

(21) Appl. No.: 13/387,317

(22) PCT Filed: Jul. 27, 2010
(86) PCT No.: PCT/US10/43341

§ 371 Date: Mar. 21, 2012

Related U.S. Application Data
(60) Provisional application No. 61/228,867, filed on Jul. 27, 2009.

(51) Int. Cl. F26B 7/00; F26B 3/00

(52) U.S. Cl. 34/427; 34/443

(57) ABSTRACT

A method for drying grain with a single drying step is based on the glass transition temperature (Tg) hypothesis. The air used to dry the grain is maintained at a sufficient temperature and relative humidity (RH) such that the grain remains entirely in the rubbery state during the drying process, which prevents the formation of fissures that result from the transition of the grain to the glassy state at the grain kernel periphery. The result of the process is an improved head rice yield (HRY) comparable to longer, multi-step drying methods but which may be accomplished in less time and with lower energy requirements.

### TECHNICAL FIELD

The invention pertains to the area of grain drying.

### BACKGROUND ART

Since ancient times, farmers have used various methods to dry rice, wheat, and other grains in order to safely store them for later use and prevent spoilage. Grain gains or loses moisture based on the current moisture content (MC) of the grain as compared to the temperature and relative humidity of the air around it. According to relationships that are well known, rice or other grain placed in a constant temperature and constant humidity air stream will eventually attain an equilibrium MC that corresponds to the air humidity and temperature. The desired MC for different grains varies. For example, it is generally considered preferable to store rough rice at a 12.5 to 13% MC (wet basis).

Grain dries faster if it is exposed to higher airflow rates, higher air temperatures, or lower relative humidities. Commercial rice dryers are expensive to construct and require considerable energy to operate, and thus it may be seen that it would be desirable to increase the speed at which rice drying occurs. Drying grain too quickly using conventional methods, however, can lead to fissuring, which reduces the milling yield for the grain. As a result, current state-of-the-art grain dryers employ multiple drying passes, with typical tempering durations between passes of 12 to 30 hours. The rest or “tempering” periods allow the moisture content between the outer kernel and inner kernel of the grains to equalize, thereby reducing the likelihood of kernel fissure development. The requirement of tempering periods and multiple passes in commercial rice drying greatly slows down the speed at which drying can be performed, thereby reducing the throughput of large, commercial rice dryers. This multi-step process also greatly increases the energy consumption, and hence the operational costs, of using commercial dryers. This slow, multi-step process is necessary, however, to protect grain quality.

Numerous types of grain dryers are known in the art. One common type of dryer, often referred to as a column dryer, allows grain to flow by force of gravity downward between two screens. Hot air flows horizontally through the dryer, crossing the path of grain flow perpendicularly. Metering rolls at the bottom of each column control the rate at which rice moves through the dryer. Some column dryers use turnflows to improve grain-to-grain drying uniformity. Other types of dryers include baffle dryers, which cause grain to flow in a zigzag pattern with heated air introduced from a plenum through openings between baffles, and the “LSU” dryer, which employs an array of inverted V-shaped troughs past which rice flows, with the open space below each trough used to distribute heated air. A newer type of dryer is the fluidized bed dryer, in which grain is suspended on a fluidized bed in a hot air stream moving at high velocity. None of these existing commercial grain dryers are capable, however, of producing a quick, single-pass drying regime that does not result in considerable loss of dried grain quality using conventional methods.

Research in the general area of preventing endosperm fissuring in rice kernels began at The University of Arkansas Rice Processing Program in the mid-1990s. A key effort was to measure the glass transition temperature (Tg) relationship of rice kernels. Depending on the temperature and MC of a kernel of rice (or other grain), it can behave as a flexible “rubbery” state or a more solid-like “glassy” state. The Tg relationship comprises an inverse, linear line relating a rice kernel's Tg with its MC. The Tg line separates the “glassy” region (below the Tg line) from the “rubbery” region (above the Tg line). This work resulted in publications including Siebenmorgen, T. J., W. Yang, and Z. Sun, Glass Transition Temperature of Rice Kernels Determined by Dynamic Mechanical Thermal Analysis, Trans. of the ASAE 47(3): 835-839 (2004); and Perdon, A. A., T. J. Siebenmorgen, and A. Mauromoustakos, Glassy State Transition and Rice Drying: Development of a Brown Rice State Diagram, Cereal Chemistry 77(6):708-713 (2000). Related materials include Schluterman, D. A. and T. J. Siebenmorgen, Relating Rough Rice Moisture Content Reduction and Tempering Duration to Head Rice Yield Reduction, Trans. of the ASABE, 50(1):137-142. (2007); Schluterman, G. and T. J. Siebenmorgen, Air and Rice Property Profiles within a Commercial Cross-Flow Dryer, Applied Engineering in Agriculture 20(4):487-494, (2004); Cnossen, A. G., T.J. Siebenmorgen and W. Yang, The Glass Transition Concept in Rice Drying and Tempering: Effect on Drying Rate, Trans. of the ASAE 45(3):759-766, (2002); Cnossen, A. G., M. J. Jimenez, and T. J. Siebenmorgen, Rice Fissuring Response to High Drying and Tempering Temperatures, Journal of Food Engineering 59(1):61-69, (2003); and Cnossen, A. G. and T. J. Siebenmorgen, The Glass Transition Temperature Concept in Rice Drying and Tempering: Effect on Milling Quality, Trans. of the ASAE 43(6):1661-1667, (2000).

This basic work has been applied to the process of rice drying. One of the key objectives in drying rice, as noted above, is to reduce MC without causing internal fissures or cracks in the kernel endosperm. The application of the basic Tg research work cited above in explaining fissure formation and resultant milling quality reduction during the drying process is referred to as the “Tg hypothesis” (Cnossen and Siebenmorgen, 2000; Schluterman and Siebenmorgen, 2007). The hypothesis states that if a kernel is heated above its Tg, as is typical during conventional drying, the entire kernel will transition from a rubbery to a glassy state. In the rubbery state, diffusion of moisture occurs at a much greater rate, and thus drying and tempering proceed much more rapidly than in the glassy state (Cnossen et al., 2002). As drying proceeds with low relative humidity (RH) air, the kernel periphery will dry to low MC, causing the surface to transition to the glassy state. If too great a volume of the kernel periphery transitions into the glassy region while the center core remains in the rubbery region, the tremendous differences in properties between the material states (Perdon et al., 2000) will produce sufficient intra-kernel stress differentials to cause fissuring. A similar fissuring phenomenon is hypothesized and has been observed (Schulterman and Siebenmorgen, 2007) when kernels are removed from drying and immediately cooled to temperatures below the Tg when an intra-kernel MC gradient exists.

The Tg hypothesis has been validated in laboratory experiments (Cnossen and Siebenmorgen, 2000; Cnossen et al., 2003; Schluterman and Siebenmorgen, 2007). Additionally, Schluterman and Siebenmorgen, 2004 have shown that state transitions can occur inside currently produced commercial rice dryers, and that the Tg hypothesis can be used to explain milling quality reduction during high-temperature drying.

Developing a drying method that increases the milling quality of grain based on the Tg hypothesis would be highly desirable because it could increase the throughput of dryers and lower associated energy usage, thereby lowering the costs associated with grain drying. Such a drying method would also be environmentally beneficial because of the lower energy usage required. These desired advantages are achieved, and the limitations of the prior art are overcome, by the present invention as described below.

### DISCLOSURE OF THE INVENTION

The present invention is directed to a grain drying method based on the Tg hypothesis that controls drying air relative humidity (RH) such that the grain kernel periphery does not transition into the glassy state during drying. As such, the kernel periphery and core both remain in the rubbery state, thereby preventing intra-kernel state property differences, and resultant stress development sufficient to cause fissuring. The result is a high milling yield for the dried grain even when a relatively short, one-pass drying process is employed.

These and other features, objects and advantages of the present invention will become better understood from a consideration of the following detailed description of the preferred embodiments and appended claims in conjunction with the drawings as described following:

### BRIEF DESCRIPTION OF DRAWINGS

FIG. 1 is a line graph depicting drying curves for rice samples dried at 70° C. and 53, 73, and 83% relative humidity (RH).

FIG. 2 is a state diagram indicating the location of rice kernel material states for kernels exposed to air at 13, 53, and 73% RH and 70° C.

FIG. 3 is a line graph depicting head rice yields of samples dried at 70° C. and 13, 23, 33, 43, 53, 63, 73, and 83% RH to 12.5% moisture content.

### BEST MODE FOR CARRYING OUT THE INVENTION

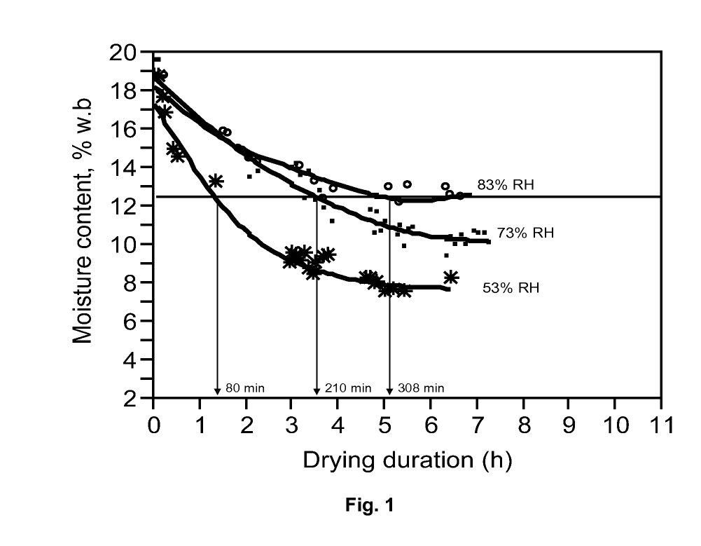

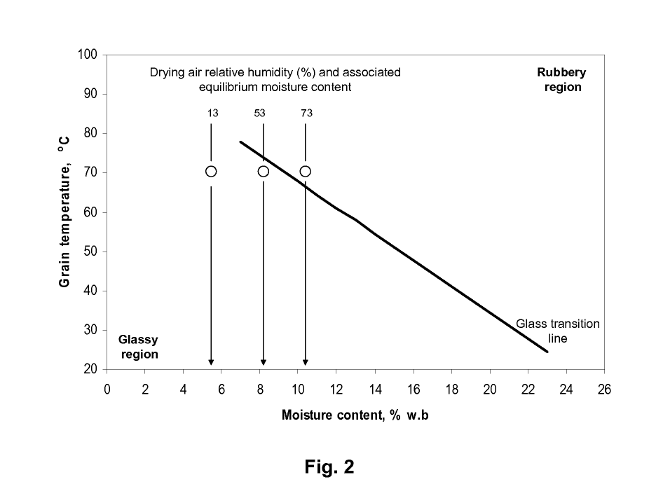

According to a preferred embodiment of the present invention, a dryer is employed in which drying air RH is controlled as a means of preventing kernel fissuring. An example of the results of using such an apparatus is presented in FIG. 1 for a 70° C. drying air temperature, from which asymptotic values will indicate equilibrium MCs. From the equilibrium MC data for each RH, the state points for kernel surfaces exposed to given air conditions can be plotted onto a state (Tg) diagram. FIG. 2 charts state-point locations relative to Tg for three RHs at 70° C. It may be seen that at about 70° C., the drying air RH would need to exceed approximately 60 to 65% in order for the kernel periphery to remain in the rubbery region.

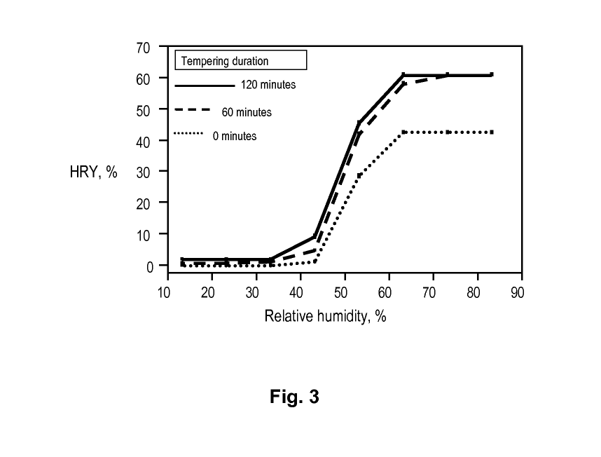

Validation of the effectiveness of the preferred embodiment is demonstrated by the data presented in FIG. 3. In these experiments, rough rice was dried in a single, continuous pass from 21% harvest MC to a desired, storage MC of 12.5% using 70° C. drying air at RHs ranging from 13 to 83%. After drying, the rice was tempered for 0, 60, or 120 min at 70° C. before cooling with 21° C. air. The samples were then milled to determine head rice yield (HRY), which is the mass percentage of unprocessed, rough rice that remains as milled, intact kernels, known as “head rice”. FIG. 3 shows that severe fissuring, as indicated by very low HRYs, occurred at low drying air RHs, as expected. However, at RHs of 63% or greater, HRYs stabilized at a high level. It is noted that the 63% RH level corresponded to approximately the same RH value that just placed kernel surfaces into the rubbery region, as shown in FIG. 2. Similar results were found at other drying air temperatures for corresponding RH levels. The tempering results are also explained by the Tg hypothesis in that when rice kernels were immediately cooled to 21° C. (0 min tempering duration), there was fissuring and lowered HRYs due to the rapid cooling while an intra-kernel moisture content gradient existed. When kernels were allowed to temper in the rubbery region for either 60 or 120 min, thereby allowing intra-kernel moisture content gradients to subside before cooling, fissuring was minimized and HRYs increased.

The preferred embodiment thus presents a method to provide single-pass drying with little to no HRY reduction. This approach can be employed or adapted for use in multiple types of existing dryer systems, including the newer fluidized bed grain drying systems.

As used herein, “comprising” is synonymous with “including,” “containing,” or “characterized by,” and is inclusive or open-ended and does not exclude additional, unrecited elements or method steps. As used herein, “consisting of” excludes any element, step, or ingredients not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Thus, additional embodiments are within the scope of the invention and within the following claims.

In general the terms and phrases used herein have their art-recognized meaning, which can be found by reference to standard texts, journal references and contexts known to those skilled in the art. The preceding definitions are provided to clarify their specific use in the context of the invention.

All publications mentioned in the specification are indicative of the levels of skill of those skilled in the art to which the invention pertains. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention as set forth in the appended claims.

1. A method of drying grain, comprising the method steps of:
(a) introducing into a grain dryer a quantity of grain comprising kernels, wherein the kernels comprise a kernel periphery and a kernel core, and wherein the kernels are heated to a rubbery state; and
(b) drying the grain by introducing air into the dryer wherein the air comprises an air temperature and an air relative humidity (RH) such that the periphery of the kernels remains in a rubbery state throughout the drying step.

2. The method of claim 1, further comprising the method step of tempering the grain kernels wherein the relative difference in moisture content (MC) between the grain kernel periphery and the grain kernel core is reduced.

3. The method of claim 2, further comprising the method step of cooling the grain kernels to room temperature after the tempering step.

4. The method of claim 3, wherein the drying step consists essentially of a single, continuous introduction of air without an intervening tempering step.

5. The method of claim 4, wherein the air introduced during the drying step comprises an RH of greater than 60%.

6. The method of claim 5, wherein the air introduced during the drying step comprises a RH of about 63%.

7. The method of claim 6, wherein the air introduced during the drying step comprises a temperature of about 70° C.

8. The method of claim 2, wherein the tempering step comprises a duration of at least 60 min.

9. The method of claim 1, wherein the grain comprises a MC at the introducing step of about 21%.

10. The method of claim 2, wherein the grain comprises a MC at the end of the tempering step of about 12.5% (wet basis).

11. A grain drying method, consisting essentially of the method steps of:
(a) introducing into a grain dryer a plurality of grain kernels, wherein the kernels comprise a kernel periphery and a kernel core, and wherein the kernels are initially in a glassy state, but wherein the kernels transition to a rubbery state upon introduction of high-temperature air;
(b) drying the kernels by introducing air into the dryer wherein the air is maintained at a temperature and relative humidity (RH) that prevents a majority of the plurality of kernels from entering a glassy state at the kernel periphery;
(c) tempering the grain kernels wherein the relative difference in moisture content (MC) between the grain kernel periphery and the grain kernel core is made more equal; and
(d) cooling the grain kernels after the tempering step.

12. The method of claim 11, wherein the drying step comprises a single, continuous introduction of air without an intervening tempering step.

13. The method of claim 12, wherein the air introduced during the drying step comprises a RH of at least 60%.

14. The method of claim 13, wherein the air introduced during the drying step comprises an RH of about 63%.

15. The method of claim 14, wherein the air introduced during the drying step comprises a temperature of about 70° C.

16. The method of claim 11, wherein the tempering step comprises a duration of at least 60 min.

17. The method of claim 11, wherein the grain comprises a MC at the introducing step of about 21%.

18. The method of claim 17, wherein the grain comprises a MC at the end of the tempering step of about 12.5% (wet basis).

19. A method for drying a plurality of grain kernels each comprising a state that is either above or below a glass transition line, the method comprising the steps of:
(a) introducing the kernels into a grain dryer with high-temperature air such that the kernels reach a temperature and a moisture content (MC) wherein the kernels are in the state above the glass transition line;
(b) drying the kernels by introducing air into the dryer wherein the majority of kernels do not pass into the state below the glass transition line; and
(c) tempering the kernels.

20. The method of claim 19, wherein the drying step comprises a single, continuous introduction of air without an intervening tempering step.

21. The method of claim 20, wherein the air introduced during the drying step comprises a RH of at least 60%.

22. The method of claim 21, wherein the air introduced during the drying step comprises an RH of about 63% and a temperature of about 70° C.
